(19) United States
(12) Patent Application Publication
(10) Pub. No.: US 2005/0116074 A1
(43) Pub. Date: Jun. 2, 2005

(54) Comminuter striker plate

(76) Inventor: Jiri Kusak, St. Catharines (CA)

Correspondence Address: RICHES, MCKENZIE & HERBERT, LLP, SUITE 1800, 2 BLOOR STREET EAST, TORONTO, ON, M4W 3J5, CA

(21) Appl. No.: 10/724,188

(22) Filed: Dec. 1, 2003

(51) Int. Cl. B02C 13/28

(52) U.S. Cl. 241/195; 241/294

(57) ABSTRACT

A comminuting apparatus having a rotor for rotation about a horizontal axis relative to a stator, the rotor having replaceable rotor striker plates secured thereto with a cutting side surface disposed radially outwardly from an outer most radial perimeter of the rotor, the cutting side surface of the rotor having axially spaced rotor teeth with radially inwardly extending rotor grooves between adjacent rotor teeth, a stationary anvil fixed to the stator radially outwardly of the rotor extending axially of the rotor and presenting replaceable anvil striker plates secured thereto with a cutting side surface disposed radially inwardly from an inner most radial perimeter of the stator towards the rotor, the cutting side surface of the stator having axially spaced stator teeth with radially inwardly extending stator grooves between adjacent stator teeth, the stator teeth alternating axially with the rotor teeth with each stator tooth disposed in a rotor groove spaced therefrom extending radially inwardly into the rotor groove radially inwardly of the radially outermost portions of the adjacent rotor teeth and with each rotor tooth disposed in a stator groove extending radially outwardly into the stator groove radially outwardly of the radially innermost portions of the adjacent stator teeth, wherein at every axial point a radially extending gap is provided between the cutting side surface of the rotor striker plates and the cutting side surface of the stator striker plates, the radially extending gap varying in radial extent over the axial extent of at least some of the stator grooves and rotor grooves.

### FIELD OF THE INVENTION

This invention relates to various shredding, shearing, tearing, cutting and grinding devices which process small pieces of bulk materials, such as pieces of rubber tires, into crumb-sized particles.

The present invention more particularly relates to an apparatus for comminuting that is, performing a plurality of size reducing actions by a rotor mounted for rotation within a reduction chamber and, more particularly, to a striker plate carried by a rotor, preferably on lobes of the rotor, which cooperate with a stationary anvil which also preferably carries identical striker plates. The invention further relates to a configuration of an anvil to facilitate changing of striker members of the anvil.

### BACKGROUND OF THE INVENTION

In general, a comminuter comprises a housing with a reducing chamber having an inlet for feeding material to the reducing chamber and an outlet for discharging material of reduced size. A rotor is arranged in the reducing chamber and is mounted on a horizontal drive shaft driven by a suitable motor. A plurality of striker plates are mounted along the periphery of the rotor radially of the rotor, and each has a striking surface or cutting edge oriented in the general direction of rotation of the rotor. The feed is caught between striker plates on the rotor and an anvil spaced from the striker plates. With revolution of the rotor, the feed pieces are sheared, cut, ground and the like to reduce their size. Preferably, the anvil also carries striker plates with cutting edges spaced from the cutting edges of the striker plates on the rotor.

Typical prior art heavy duty material reduction apparatus utilizing impact rotors of the type under consideration are disclosed in U.S. Pat. No. 5,402,948 Kaczmarek and U.S. Pat. No. 4,151,959 to Deister. These patents are illustrative of the prior art utilizing either a radially attached, axially or helically extending cutter bar or striker plate.

The Kaczmarek patent, for instance, illustrates a cutter bar extending axially on the surface of a rotating drum over the entire length of the drum. The cutter bar is shown with multiple removable cutting teeth-like striker plates mounted thereon for cutting in cooperation with cutting teeth-like striker plates carried on a stationary anvil. The Deister patent illustrates still another type of impact rotor comprised of a series of rotary discs with offset, radially extending lobes for mounting removable striker plates. A disadvantage in both these types of apparatus is that the cutter teeth or striker plates have a leading cutting edge subject to severe wear and deterioration. This is disadvantageous because it is necessary to completely remove the cutting edge wear component from the rotor or anvil in order to replace a cutting edge or to change or reverse the position of the cutter tooth or striker plate to present a new cutting edge. A disadvantage, particularly with heavy duty rotary hogs, is that this operation is expensive and time consuming. An associated disadvantage is that known cutter teeth and striker plates are expensive to manufacture and often are custom made for different positions on the rotor or anvil.

### SUMMARY OF THE INVENTION

To at least partially overcome these disadvantages, the present invention provides an improved striker plate for a rotor or anvil in a comminuter used for the size reduction of feed material as by cutting, shearing, pulverizing and the like, most preferably, for comminuting rubber.

An object of the present invention is to provide an improved striker plate which is inexpensive and as well is adapted to be mounted in a manner which is easy to change and is cost effective.

Another object is to provide a configuration for an anvil in a comminuting apparatus which facilitates change of striker members of the anvil.

The present invention provides a striker plate carrying a cutting edge adapted for attachment to a rotor or an anvil of a size reducing apparatus.

The striker plates in accordance with the present invention are adapted for use to size reduce materials which are difficult to reduce such as multi-grade materials like rubber tires which comprise not only rubber but also steel and material cord. The striker plates provide cutting flexibility which reduces the impact force experienced by each cutting and allows the striker plates to strip coatings off of steel belted cord passing vertically between opposed cutting edges and to cut like material passing between opposed cutting edges and further to cut, shred, tear and grind various work materials.

In accordance with preferred embodiment of the invention, only one rotating grinding drum is employed and a stationary anvil carries striker plates with cutting edges on the drum housing. This is advantageous in that, if desired, close clearances may be established between the cutting edges on the striker plates on the rotor and cutting edges on the striker plates on the stator anvil such that the comminuting action may be primarily a cutting action although shearing, tearing, grinding, and ripping actions occur. Where the clearances between the cutting edges of the striker plates on the rotor and stator are smallest, the cutting edges co-act to shear material fed into the space therebetween.

In one aspect, the present invention provides a striker plate for a rotatable rotor or stationary anvil of a rotary comminuting device comprising:
a striker plate having:
a first end face,
a second end face,
a rear face for attachment to a rotor or anvil,
a front face parallel the rear face,
a right cutting side face extending between the rear face and the front face on a right side thereof, and
a left cutting side face extending between the rear face and the front face on a left side thereof,
a right rear cutting edge formed at a juncture between the right side cutting face and the rear face,
a right front cutting edge formed at a juncture between the right side cutting face and the front face,
a left front cutting edge formed at a juncture between the left side cutting face and the front face,
a left rear cutting edge formed at a juncture between the left side cutting face and the rear face,
the right cutting side face comprising a plurality of identical planar right lands interspaced by a plurality of identical, parallel right grooves,
the right lands all lying in the same flat right land plane and each spaced from each adjacent right land by one of the right grooves, the right land plane disposed at a first angle to the rear face,
each right groove comprising a frusto-cylindrical surface of an angular extent not greater than 180 degrees about a respective groove axis extending at a second angle to the rear face,
each respective groove axis for all of the right grooves lying in a same right axis plane,
the left cutting side face comprising a plurality of identical planar left lands interspaced by a plurality of identical, parallel left grooves,
the left lands all lying in the same flat left land plane and each spaced from each adjacent left land by one of the left grooves, the left land plane disposed at the first angle to the rear face,
each left groove comprising a frusto-cylindrical surface of an angular extent not greater than 180 degrees about a respective groove axis extending at the second angle to the rear face,
each respective groove axis for all of the left grooves lying in a same left axis plane,
the right land plane parallel to the left land plane.

In another aspect the present invention provides a comminuting apparatus having:
a rotor for rotation about a horizontal axis relative to a stator,
the rotor having replaceable rotor striker plates secured thereto with a cutting side surface disposed radially outwardly from an outer most radial perimeter of the rotor,
the cutting side surface of the rotor having axially spaced rotor teeth with radially inwardly extending rotor grooves between adjacent rotor teeth,
a stationary anvil fixed to the stator radially outwardly of the rotor extending axially of the rotor and presenting replaceable anvil striker plates secured thereto with a cutting side surface disposed radially inwardly from an inner most radial perimeter of the stator towards the rotor,
the cutting side surface of the stator having axially spaced stator teeth with radially inwardly extending stator grooves between adjacent stator teeth,
the stator teeth alternating axially with the rotor teeth with each stator tooth disposed in a rotor groove spaced therefrom extending radially inwardly into the rotor groove radially inwardly of the radially outermost portions of the adjacent rotor teeth and with each rotor tooth disposed in a stator groove extending radially outwardly into the stator groove radially outwardly of the radially innermost portions of the adjacent stator teeth,
wherein at every axial point a radially extending gap is provided between the cutting side surface of the rotor striker plates and the cutting side surface of the stator striker plates,
the radially extending gap varying in radial extent over the axial extent of at least some of the stator grooves and rotor grooves.

Further aspects and advantages of the present invention will be apparent from the accompanying drawing and description in which there is illustrated preferred embodiments of the invention.

### BRIEF DESCRIPTION OF THE DRAWINGS

Reference is made to the accompanying drawings in which:

FIG. 1 is a pictorial view of a comminuting apparatus in accordance with the first embodiment of this invention;

FIG. 2 is a schematic front view of the comminuting device shown in FIG. 1;

FIG. 3 is a schematic right side view of the comminuting device shown in FIG. 1;

FIG. 4 is a pictorial view of the reducing chamber and rotor of the comminuting device shown in FIG. 1;

FIG. 5 is a schematic pictorial view of the rotor and stator shown in FIG. 4 from the same angle of view as seen in FIG. 4;

FIG. 6 is a schematic pictorial view showing the rotor and stator of FIG. 4, however, from an opposite side to that in FIG. 5;

FIG. 7 is a top view of the rotor and stator of FIG. 4 normal to the top surface of the stator anvil;

FIG. 8 is a schematic cross-sectional side view along section line 8-8′ of FIG. 7;

FIG. 9 is an enlarged schematic cross-sectional side view of the anvil and radial edge of the rotor as seen in FIG. 8;

FIG. 10 is a schematic pictorial view of the anvil of the stator of FIG. 4 with a cover plate removed and schematically showing a single striking plate of the rotor;

FIG. 11 is a pictorial view of the radial outside of the stator anvil as seen in FIG. 10;

FIG. 12 is a pictorial view of one rotor disc of the rotor in FIG. 4;

FIG. 13 is a pictorial view of a preferred striker plate in accordance with the present invention as illustrated in FIGS. 1 to 12;

FIG. 14 is a top view of the striker plate of FIG. 13;

FIG. 15 is a side view of the striker plate of FIG. 13;

FIG. 16 is an end view of the striker plate of FIG. 13;

FIG. 17 is a top view of a steel plate showing a method of manufacture of the striker plate of FIG. 13;

FIG. 18 is a schematic top view illustrating two striker plates on the anvil and one striker plate on a segment of the rotor as seen in FIG. 10;

FIG. 19 is an enlarged view of the top view of FIG. 14 in the dotted semi-circular outline;

FIG. 20 is an enlarged view similar to FIG. 19 but with the striker plates on the anvil displaced axially relative the striker plate on the rotor compared to that in FIG. 19;

FIG. 21 is a top view similar to FIG. 26 of opposed side edges of a stator striker plate and a rotor strike plate with symmetrical pyramidal teeth centered in corresponding grooves;

FIG. 22 is a top view the same as FIG. 21 but with the teeth not centered in the grooves;

FIG. 23 schematically illustrates a portion of a striker plate as seen in top view in FIG. 14, as being shown to being manufactured by a milling process;

FIG. 24 is an end view similar to FIG. 8 but of an arrangement including two stators at each end of a screen;

FIG. 25 is a cross-sectional view along section line A-A′ in FIG. 24 showing a mechanism to locate the anvil striker plates axially;

FIG. 26 is an end view similar to FIG. 16 but of a second embodiment of a striker plate in accordance with the invention;

FIG. 27 is an end view similar to FIG. 16 but of a third embodiment of a striker plate in accordance with the invention; and

FIG. 28 is an end view similar to FIG. 16 but of a fourth embodiment of a striker plate in accordance with the invention.

### DETAILED DESCRIPTION OF THE INVENTION

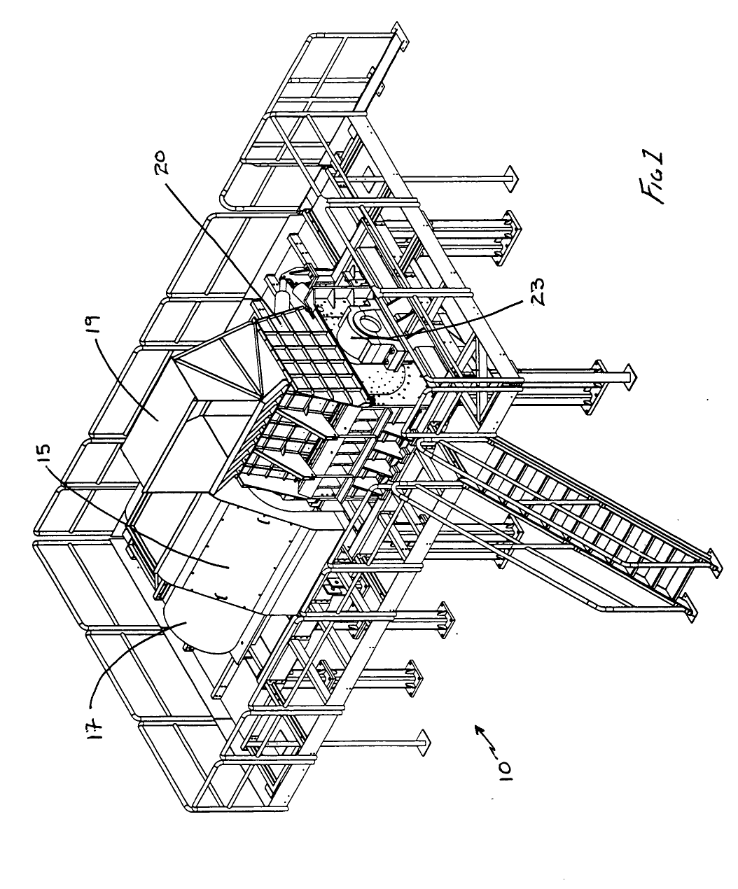

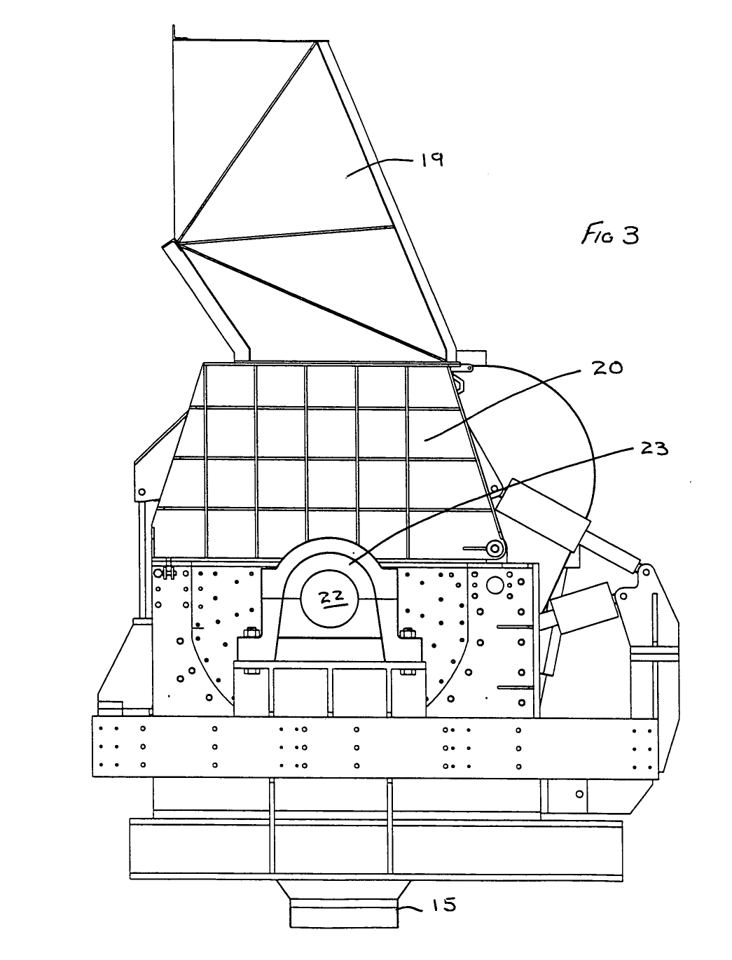

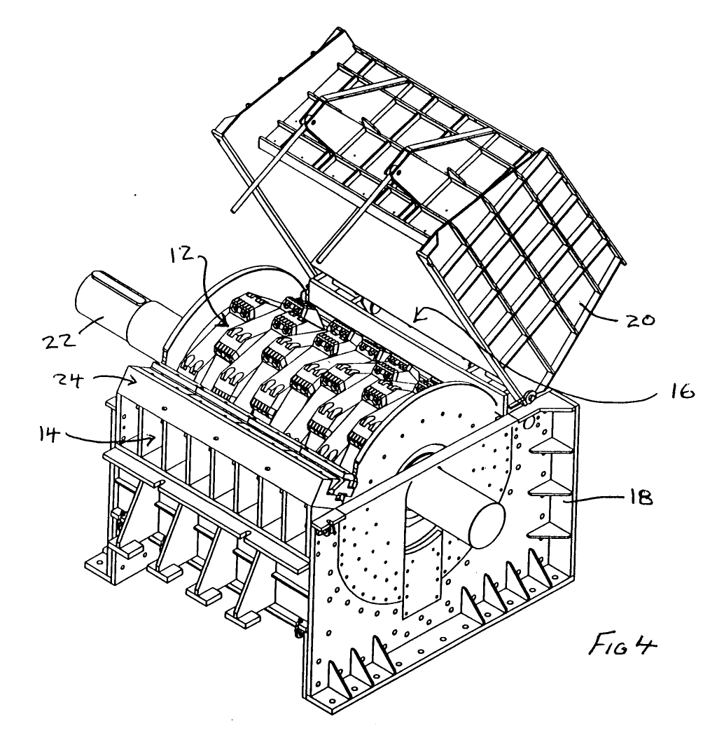

Reference is made to FIGS. 1 to 4 which show a first embodiment of a comminuting device 10 in accordance with the present invention. As best seen in FIG. 4, a rotor 12 is mounted within a stator 14 with the stator forming a reducing chamber 16. The reducing chamber 16 is formed between a lower portion 18 of the stator and an upper hopper forming lid 20 which is shown in a closed position in FIGS. 1 to 3 and in an open position in FIG. 4 to reveal notably the rotor 12 disposed for rotation about its horizontally extending shaft 22 and a stationary anvil 24 secured to the lower portion 18 of the stator 14.

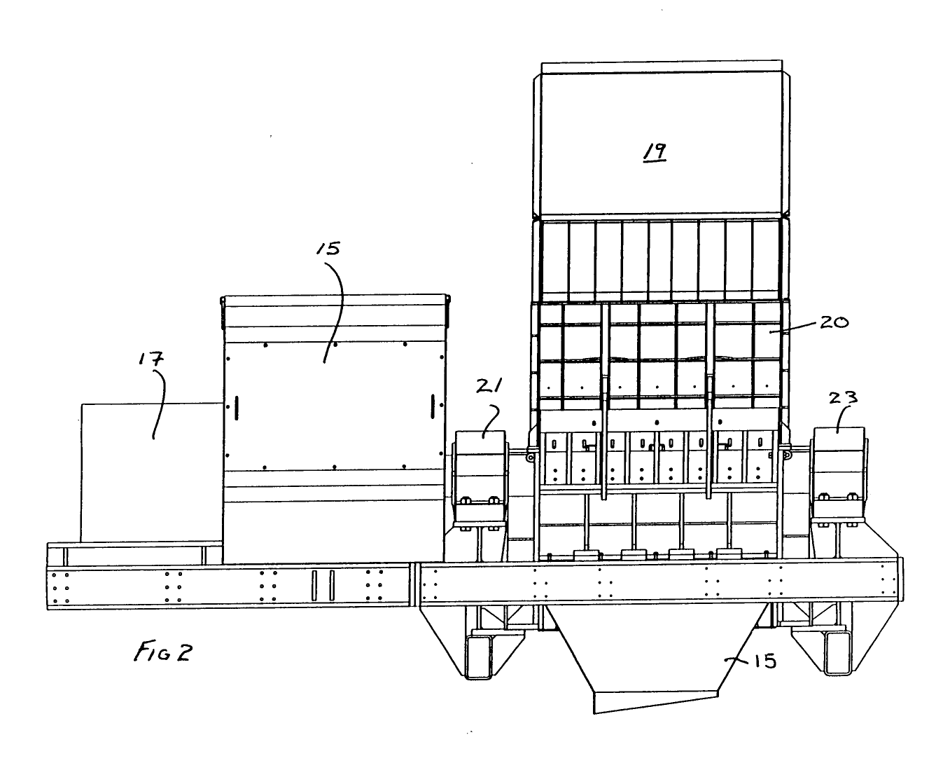

As is known, the shaft 22 of the rotor 12 is journalled in bearings 21 and 23 at either side as seen in FIG. 2. The shaft 22 is coupled to a motor 17 as preferably via connecting drive belts, not shown, disposed within belt drive housing 15.

As is known, the reducing chamber 16 has a bottom surface comprising a screen, not shown other than as 130 in FIG. 24, which is disposed radially outwardly from the rotor 12 proximate thereto. Material to be sized reduced is introduced into an entrance chute 19 of the upper hopper lid 20, drops down into the reducing chamber 16 where it becomes engaged between the rotor 12 and anvil 24 to be sized reduced and, hence, is moved down into the bottom of the reducing chamber 16 with sufficiently fine particles passing through the screen and down into a discharge duct 15.

The comminuting device in accordance with the present invention is particularly adapted for comminuting small chunks of feed material, notably small chunks of tires having steel belts and other material cores. The feed chunks are preferably tire material having outer dimensions of approximately three to four inches and the comminuter preferably reduces such input material to a relatively small mesh size, preferably, to form crumb rubber with a particle size of approximately one-sixteenth inch to five-eighths inch diameter and larger. The comminuting device in accordance with the present invention is, however, adapted for comminuting various other types of material.

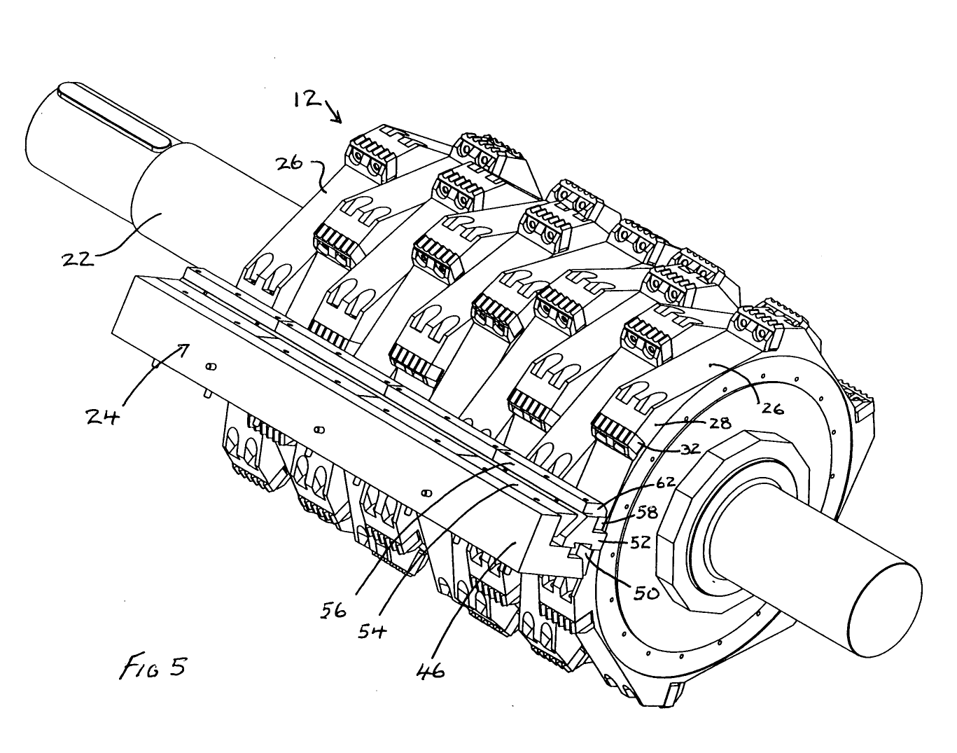

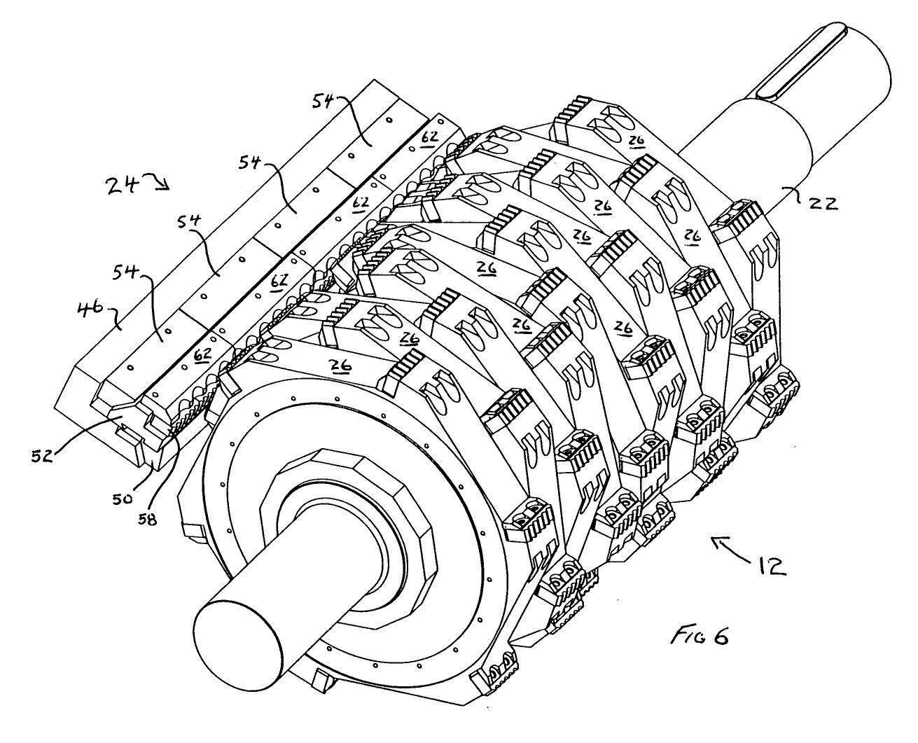

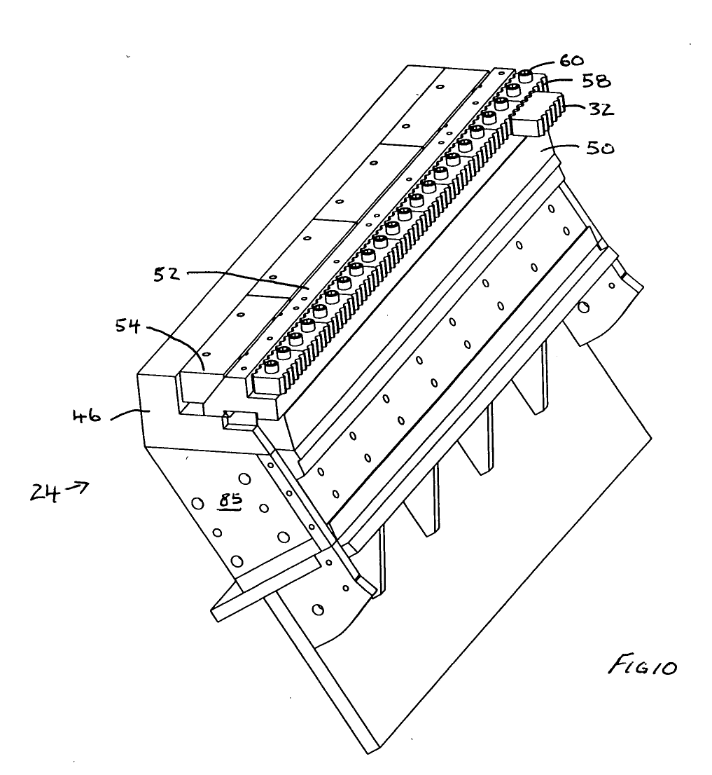

As seen in FIGS. 4 to 7, the preferred rotor 12 is of a segmented type comprising a plurality of rotor discs 26 which are keyed to the shaft 22 for rotation therewith. One disc 26 is illustrated in FIG. 12. Each rotor disc 26 carries a plurality of radially outwardly extending rotor lobes 28. Each rotor lobe 28 provides a striker carrying face 30 for supporting a rotor striker plate 32. As seen only in FIG. 12, each stator striker plate 32 is secured to the rotor lobe 28 by means of a pair of bolts 31 (one of which is shown) passing through bores through a clamp plate 34, striker plate 32 and the rotor lobe 28 to engage threaded nuts 37 which are to engage a rear face 36 of the lobes. The nuts 37 are protected, in part, by being received within recessed channels 38 in the rear of the lobes 28. The clamp plate 34 has a material deflecting outer surface 40 raised above forward surfaces 42 on which the heads 35 of the bolts 31 sit such that the heads 35 of the bolts 31 are received within channels 44 in the clamp plate 34 and are, at least to some extent, protected against wear. For ease of illustration, the bolt 31 and nut 33 are not shown other than on FIG. 12.

Preferably, openings 33 through the striker plate 32 through which the bolts 31 pass may be of a diameter larger than the diameter of the bolts 31 such that the striker plate 32 may be moved relative to the clamp plate 34 and, thus, the relative position on the striker plate 32 relative to the rotor lobe 28 may be suitably adjusted.

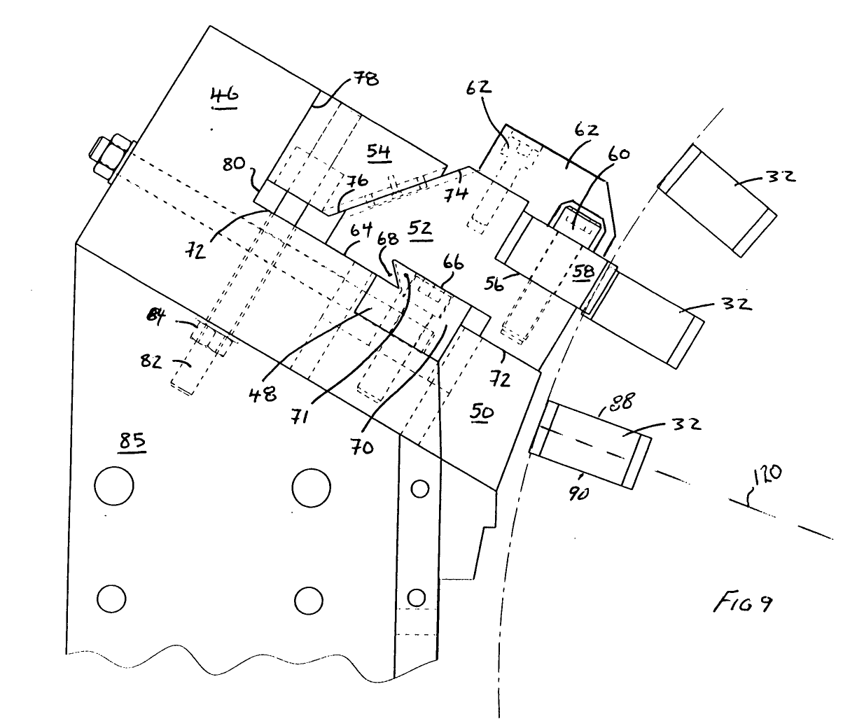

Reference is made to FIGS. 5, 6, 9, 10 and 11 which illustrate the anvil 24 which comprises a number of components including an anvil base 46, a latch rib member 48 and a wear bar 50 which are secured together so as to form, in combination, an anvil table upon which there is mounted a driven wedge 52 and a drive wedge 54.

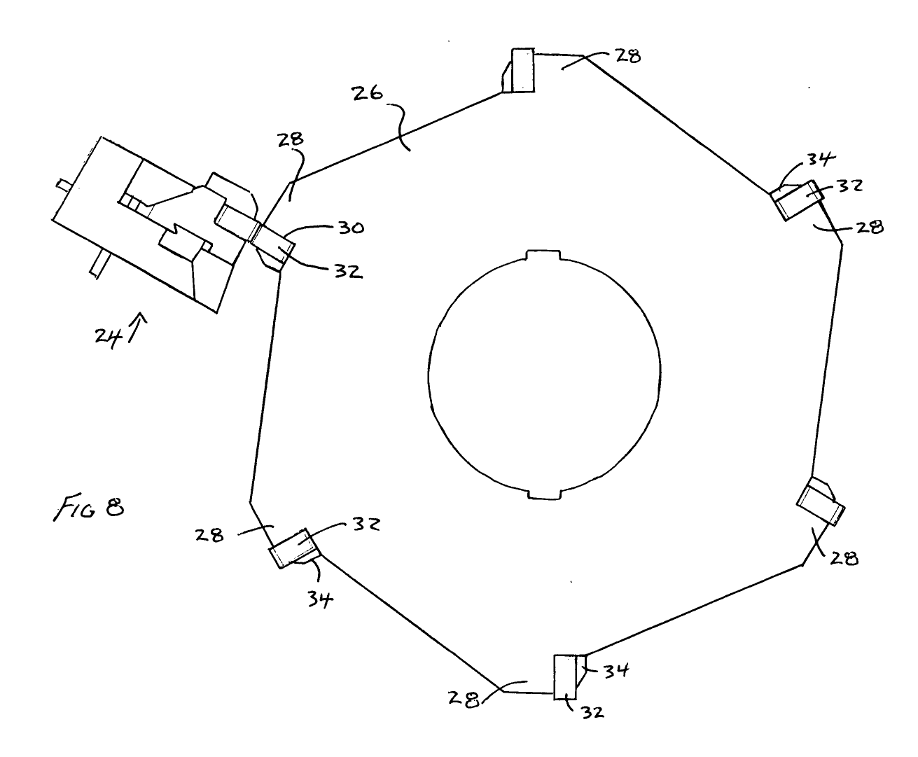

As best seen in FIG. 9, the driven wedge 54 has a striker carrying face 56 to which a anvil striker plate 58 is secured by bolts 60. A cover plate 62 is secured via bolts 63 on top of the driven wedge 52 and anvil striker plate 58 to protect the bolts 60 from wear. Driven wedge 52 has a bottom surface 64 into which there is cut a keyway 66 which has a radial outward shoulder 68 which extends inwardly and radially outwardly.

The anvil table formed as a composite of the anvil base 46, latch rib member 48 and wear bar member 50 together provide a flat planar table surface 72 upon which the bottom surface 64 of the driven wedge 52 mates and is slidable. A cam rib 70 carried on the latch rib member 48 extends upwardly into the keyway 66 in the driven wedge 52 and has a radially outer shoulder 71 extending radially outwardly and upwardly at an angle and complementary to the shoulder 68 on the driven wedge 52.

The keyway 66 of the driven wedge 52 is of a radial extent greater than the radial extent of the cam rib 70, such that, when the driven wedge 52 is slid along the table surface 72 radially outwardly, the radial innermost portions of the shoulder 68 on the driven wedge 52 are radially outward of the outer shoulder 71 of the cam rib 70 and the driven wedge 52 may then be removed in a direction normal to surface 72 for replacement by another driven wedge 52.

The driven wedge 52 has an upper cam surface 74 which extends at an angle away from the table surface 72 and radially inwardly.

The drive wedge 54 has a complementary lower cam surface 76 to engage the upper cam surface 74. The drive wedge 54 also has an outer cam surface 78 which slides upon an inner shoulder 80 of the anvil base 46. A wedge stud 82 has one end secured in the drive wedge 54 and passes through the anvil base 46 to a nut 84 located underneath the anvil base 46 between vertical metal joists 85 supporting the anvil 24 to the remainder of the stator. The wedge bolts 82 extends parallel to the inner shoulder 80 of the anvil base 46. By rotating the nut 84, the drive wedge 46 can be moved towards the table surface 72 with the camming interaction of the outer cam surface 74 on the driven wedge 54 and the inner cam surface 56 of the drive wedge 54 urging the driven wedge 52 radially inwardly into a locked position in which its keyway 66 is urged radially into and is fixedly engaged on the cam rib 70, against any movement whatsoever of the driven wedge 52. As well, by loosening nut 84, the drive wedge 54 can be moved to positions in which the driven wedge 52 is free to be removed from engagement on the keyway 66.

In the preferred embodiment, each of the anvil base 46, latch rib member 48, wear bar 50 and driven wedge 52 comprise a unitary member which extends the entire axial extent of the anvil. The drive wedge 54 is illustrated as comprising four segments each controlled by two wedge bolts 82.

It will be appreciated that in accordance with the present invention, the driven wedge 52 with its anvil striker plates 58 and cover plate 62 attached may be removed in its entirety as a unit and replaced by a similar replacement driven wedge 52. The replacement driven wedge 52 may be properly set up and configured with new strike plates 58 and a cover plate 62 prior to assembly on the anvil. In this manner, all of the strike plates 58 on the anvil may be changed relatively quickly. Any new driven wedge 52 may have the striker plates 58 located thereon in a desired configuration and orientation prior to being secured to the anvil base 46.

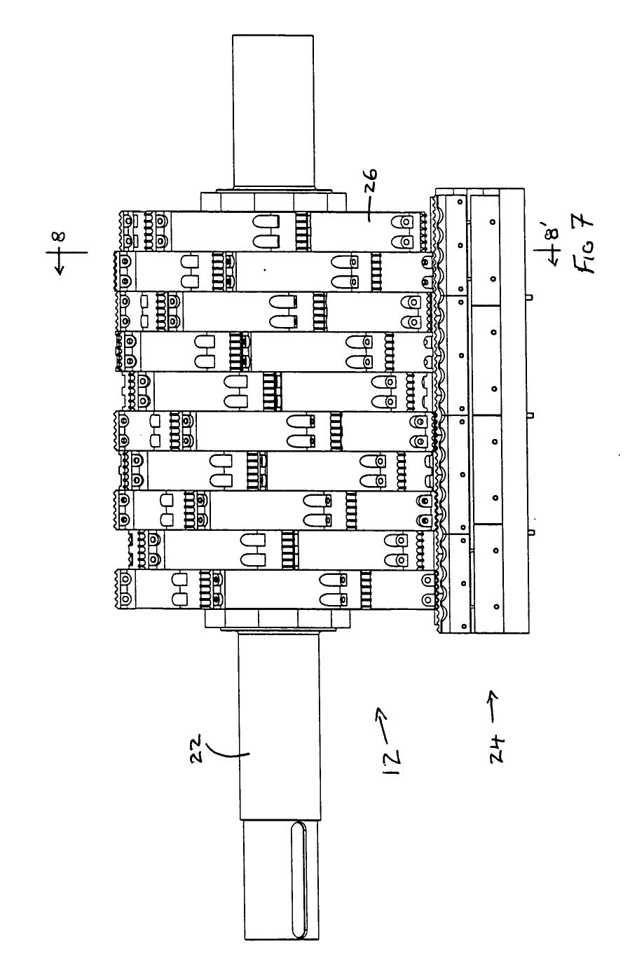

Reference is made to FIG. 24 which illustrates an end view similar to FIG. 8 but with a second stator 24 provided on the right-hand side of the rotor 26 such that two stators 24 are provided on each circumferential side of a screen 130 disposed below the rotor 26. The two stators 24 are illustrated as identical. The right-hand side stator 24 is mounted for pivoting about a horizontal hinge pin 132 extending parallel the axis of rotor 26 such that for servicing of the right-hand stator 24, the right-hand stator 24 can be swung from its use position shown in solid lines to a servicing position shown in dashed lines in which the stator 24 has its components, notably, its cover plates 62, driven wedge 52 and drive wedge 54 on top of the anvil base 46 and accessible. For use, the right-hand stator 26 is locked in the use position.

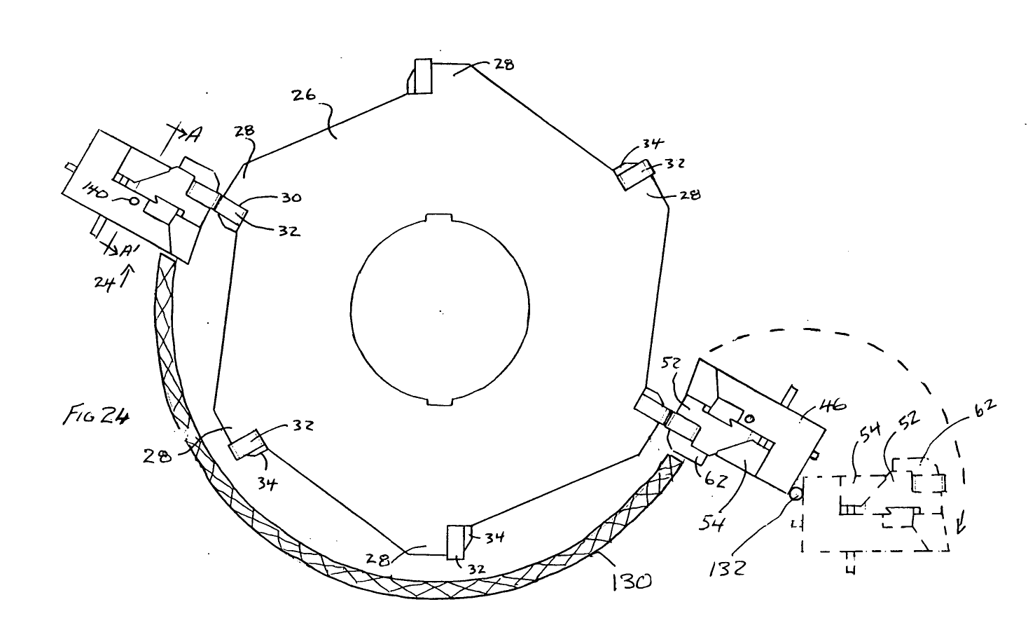

FIG. 25 illustrates in a cross-section along section line A and A′ in FIG. 24, a mechanism for moving the driven wedge 32 to different axial positions relative to the anvil base 46. A slide block 134 is received in a guideway 136 in the anvil base 46 constrained therein but for sliding parallel to the axis of the rotor as controlled and activated by a rotatable screw member 138 accessible via bore 140 in the end wall of the anvil base 46. The slide block 134 carries a key 146 received in a keyway 142 in the driven wedge 52. With the drive wedge 54 loosened sufficiently to permit axial sliding of the driven wedge 52 relative the anvil base 46, by rotation of the screw member 138, the driven wedge 52 may be moved axially as is advantageous to position the stator anvil plates 52 axially relative to the rotor striker plates 32.

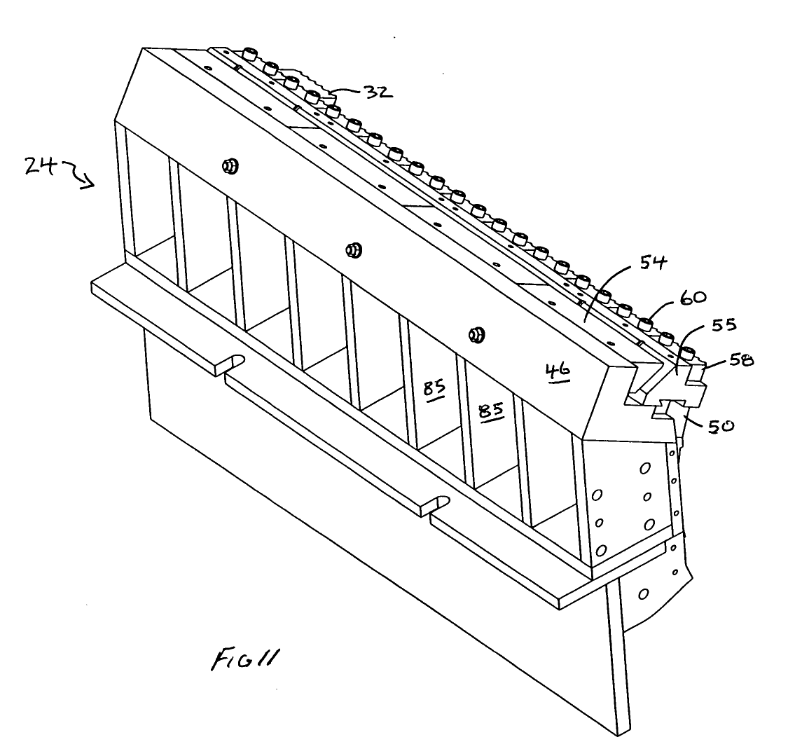

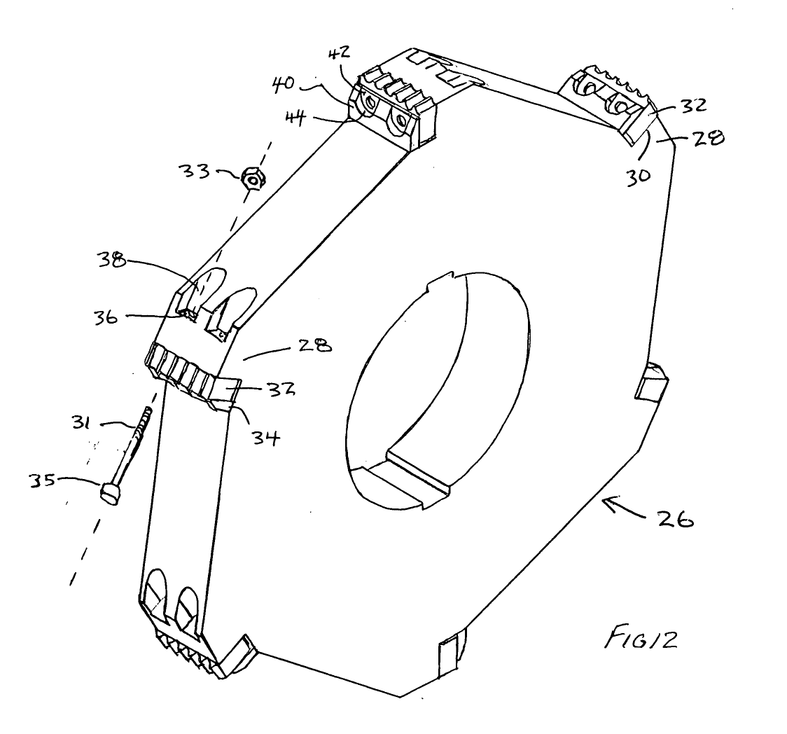

Reference is made to FIGS. 13 to 18 which illustrate a preferred striker plate 32 in accordance with the present invention and, as is illustrated in each of FIGS. 4 to 12, is suitable for use both as a rotor striker plate 32 and a stator or anvil striker plate 58. The striker plate 32 is an elongate, generally rectilinear member having a rear face 88, a front face 90 parallel to the rear face, a right cutting side face 92 extending between the rear face 88 and the front face 90 on a right side thereof, a left cutting side face 94 extending between the rear face 88 and the front face 90 on a left-side thereof, a first end face 96 and a second end face 98.

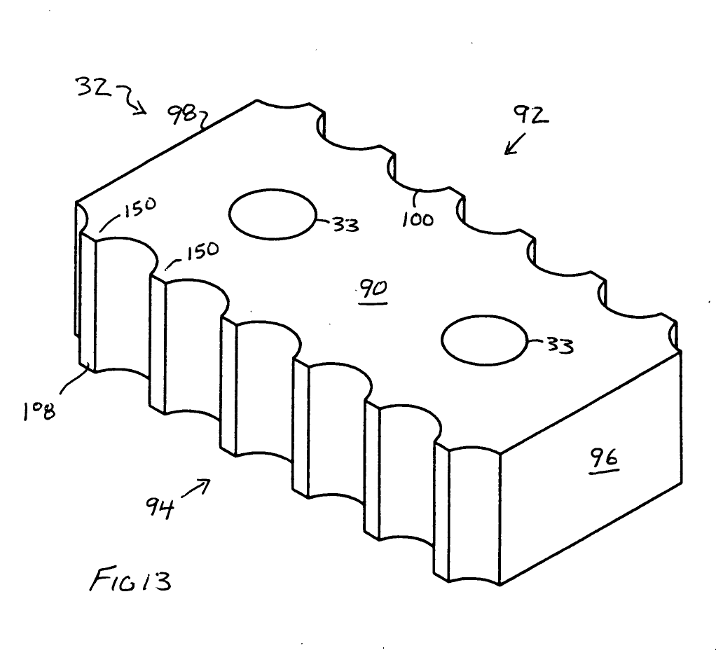

As best seen in FIG. 16, a right rear cutting edge 100 is formed at a juncture between the right side cutting face 92 and the rear face 88. A right front cutting edge 102 is formed at a juncture between the right side cutting face 92 and the front face 90. A left front cutting edge 104 is formed at a juncture between the left side cutting face 94 and the front face 90. A left rear cutting edge 106 is formed at a juncture between the left side cutting face 94 and the rear face 88.

Each of the left and right cutting side faces 92 and 94 comprise a plurality of identical lands 108 interspaced by a plurality of identical parallel grooves 110. As schematically seen in FIGS. 14 and 16, the lands 108 of each side face all lie in the same flat land plane 109. Each land 108 is spaced from an adjacent land by one of the grooves 110. Each groove comprises a frusto-cylindrical surface about a groove axis 111 extending at an angle to the front and rear faces 88 and 90. The groove axes 111 for all of the grooves 110 in the same side face of the striker plate to lie in the same axis plane 112 which is parallel to the land plane 109 in which the lands 108 on that side face lie. The lands 110 preferably have an axial extent in the range of 0.1 to 1.9 times the radius of the grooves, more preferably, 0.25 to 1.0 times, more preferably, 0.3 to 0.6 times and, preferably, about 0.5 times.

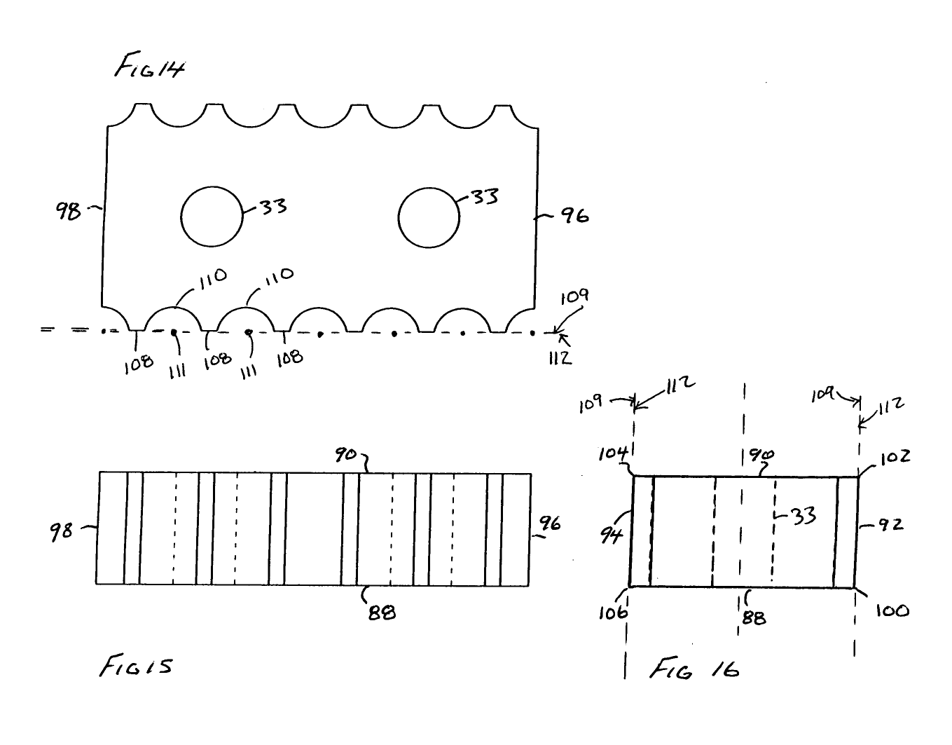

FIG. 17 shows a metal plate from which a number of striker plates 32 are made in accordance with a first preferred process for manufacture. FIG. 17 shows a top view of a portion of a flat sheet of metal 114 of uniform thickness equal to that of a desired striker plate 32 and having parallel front and rear surfaces. The surface 116 of the sheet which is shown is to become one of the rear face 88 or front face 90 for a striking plate 32.

A plurality of circular groove forming bores 120 are drilled through the sheet 114 from the surface 116. The bores 120 are preferably each disposed about an axis normal to the surface 116 of the sheet 114. In each row, the bores 120 have their axis spaced an equal distance from the axis of an adjacent bore. A plurality of locating bores 33 are also drilled through the sheet 114 suitably spaced between the rows of bores 120.

After forming all of the bores 120 in one row, the sheet is then cut along side cut lines 122 normal to the surface of the sheet along a side cut line 124 in which the axis of the bores 120 lie, thus, effectively splitting each bore 120 in half.

The sheet is also cut along end cut lines 126 preferably perpendicular to the side cut line 124 and with the end cut lines 126 being intermediate the axis of adjacent bores 12. As a result, from a flat planar sheet of metal, individual striker plates 32 are formed. Each individual striker plate is preferably heat treated so as to provide increased hardness to its various cutting edges.

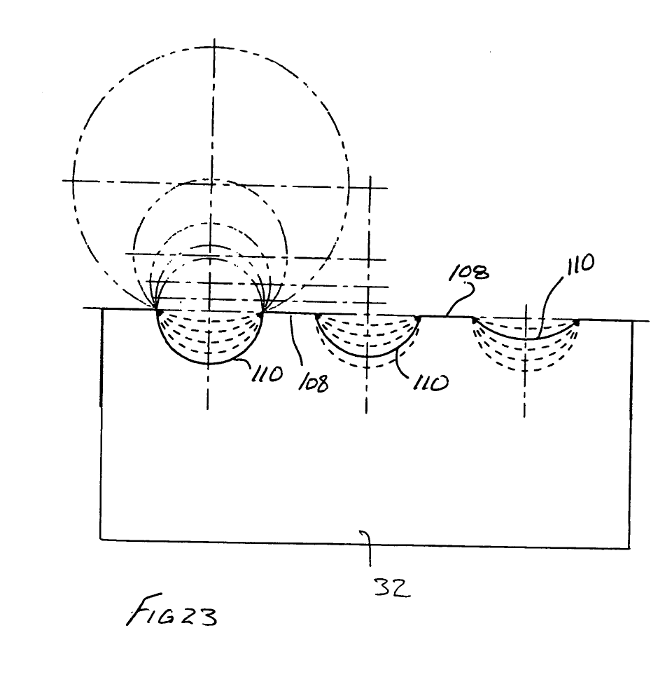

A second preferred process for manufacture of a striker plate 32 having the configuration shown in FIG. 13 is schematically illustrated in FIG. 23. As seen in FIG. 23, a plate of metal is cut into rectangular blocks after which the grooves 100 are cut into each side face as with a milling machine or router-like machine which removes material located within a circular extent of a rotating cutting head or bit. By selection of the diameter of the cutting head 4, the extent to which the milling head cuts inwardly from the side face, the depth of grooves 100 may be selected. Varying diameter grooves 100 are schematically shown by dashed lines.

A preferred striker plate 32 having the configuration described above can be manufactured relatively inexpensively using conventional metal drilling and cutting techniques.

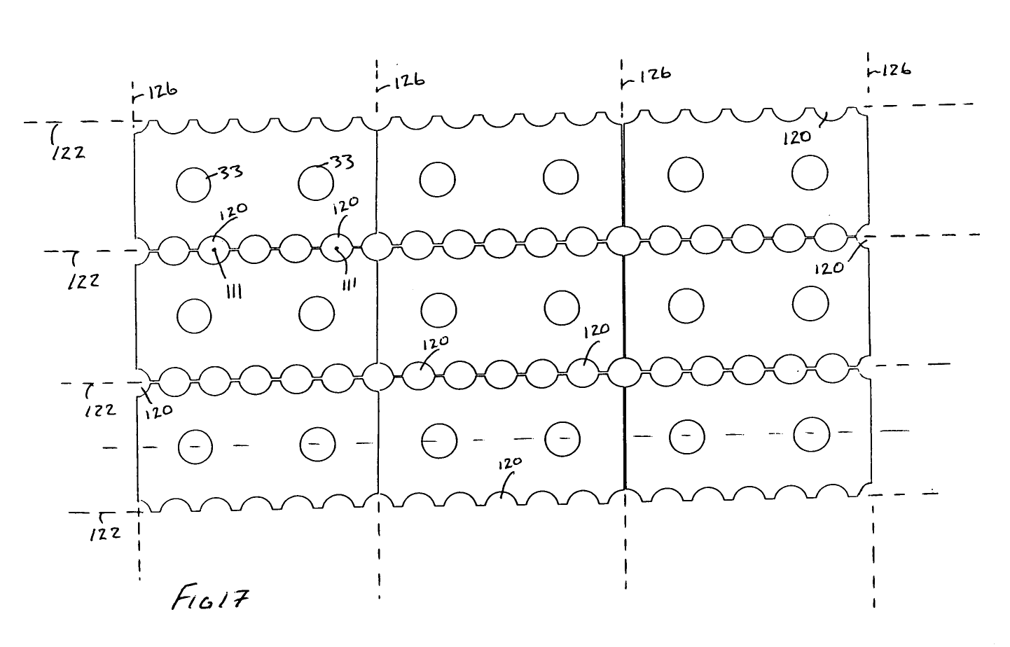

Reference is made to FIGS. 9, 10, 18 and 19 which illustrate the preferred relative positions that a striker plate 32 on the rotor 12 will assume as it passes by striker plates 58 on the stator. As best seen in FIGS. 13, 18 and 19, the lands 108 effectively form the radial outermost point of a tooth 150 for a striker plate. As best illustrated in FIGS. 18 and 19, a striker plate 32 on the rotor is disposed with its teeth 150 disposed in the grooves 110 of the striker plates 58 on the stator anvil and each tooth 150 on the striker plates 58 of the stator anvil are disposed within grooves 110 of the striker plate 32 of the rotor. In the preferred configuration, the teeth 150 and grooves 110 not only are arranged in an alternating pattern along the axial extent of the rotor and anvil but, as well, each of the teeth 150 extends radially into the groove 110 of an opposed striking plate.

The opposed striking plates 32 and 58 do not engage each other but rather are spaced from each other with a gap therebetween. In the preferred embodiment as illustrated, a gap which separates the cutting edges of one striker plate from the cutting edges of an opposed striker plate, as measured in a purely radial direction relative to the rotor 12 will vary as such gap is measured in a radial direction at different axial points or locations along the cutting edges. Thus, as seen in FIG. 19, a radial gap 152 may be measured at radially extending lines “a” to “i” spaced axially between the center of one tooth 150 and the center of an adjacent second tooth 150. The extent of the radial gap between the two cutting edges indicated as 102 and 104 varies at the different axial locations. As well, axially extending lines indicated as “k”, “l” and “m” extending parallel the axis of the rotor 12, measure the axial gap 154 between the radially overlapping portions of the teeth 150 and grooves 110 and shows the extent of the axial gap between the two cutting surfaces 102 and 104 also varies at different radial locations.

FIGS. 18 and 19 illustrate a condition in which each tooth 150 is centered axially relative to its opposing groove 110. This is not necessary and it is to be appreciated that insofar as a tooth 150 may not be axially centered in a groove 110 but offset axially to one side, then there will be an increased variance of the radial gap 152 and axial gap 154.

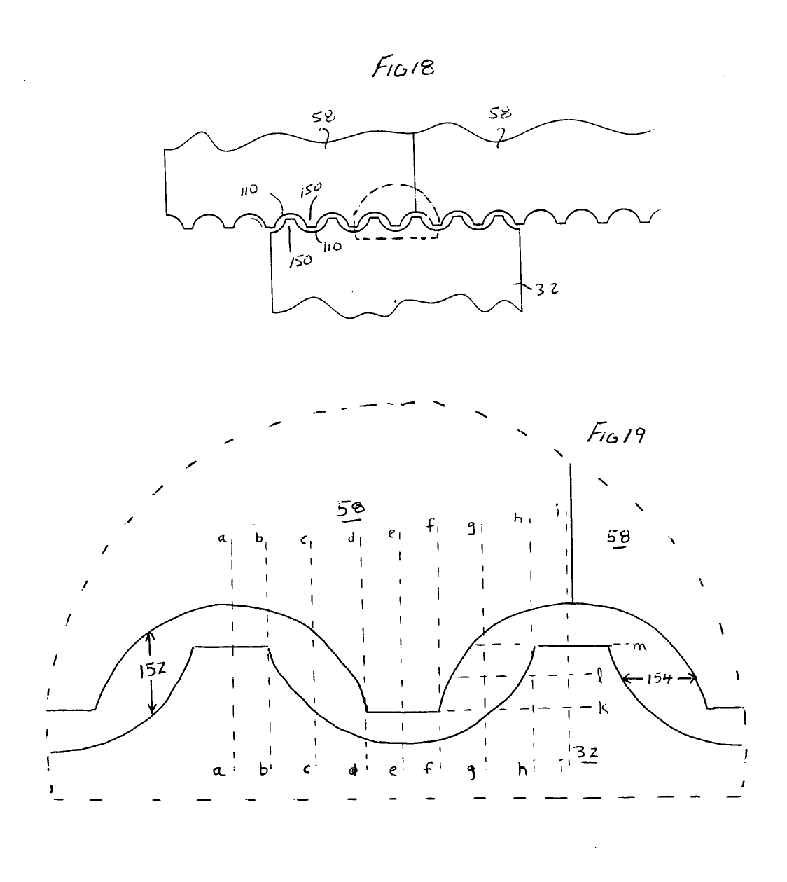

Reference is made to FIG. 20 which shows a top view identical to that in FIG. 19 but with teeth 150 not axially centered in each groove. Thus, as seen in FIG. 20, the radial gap 152 is greater on the left-hand side of each tooth 150 of the rotor striker plate 32 than on the right-hand side. As well, the axial gap 154 is also greater on the left-hand side of each tooth 150 of the rotor striker plate 32 than on the right-hand side.

In addition to the radial gap 152 and axial gap 154 being greater on the left-hand side, the cross-sectional area representing the gap, as seen in plan view normal the front surface, is greater on the left-hand side. The extent to which the radial and axial gaps may differ on each side of a tooth can be adjusted as, for example, by movement of the stator striker plates 58 axially parallel the axis of the rotor relative to the rotor. In the embodiment illustrated in FIG. 25, such axial movement is permitted by rotating adjusting screw 138. Adjusting the axial position of the striker plate on the anvil and rotor can change the nature of the resultant materials from the comminuter as to size, size distribution and rubber/metal separation.

Having the extent of the gap between the cutting edges vary is believed to be preferred so as to assist in cutting, shearing and tearing of the materials to be comminuted particularly in the case of rubber tire feed materials which may have metal, such as bands, therein. It is believed that portions of the metal may be caught or sheared between smaller gap regions while rubber about the metal may effectively be caught, compressed drawn and pulled from the metal where the rubber is caught in gaps of different radial one and/or axial dimension and overall size and shape.

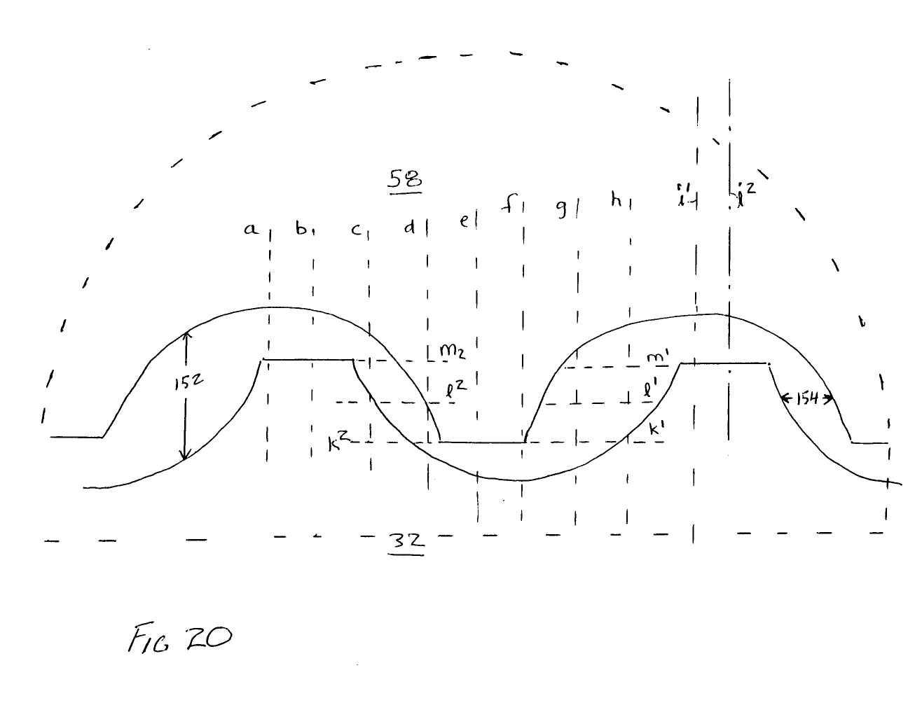

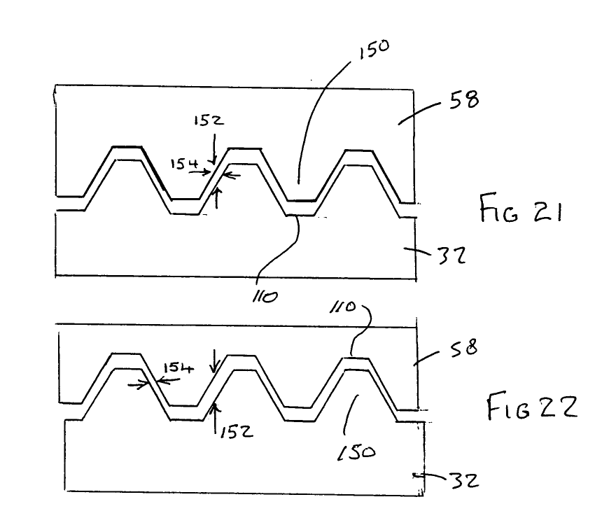

Reference is made to FIGS. 21 and 22 which schematically illustrate opposing surfaces of anvil striker plate 58 and rotor striker plates 32 which have identical alternating frusto-pyramidal teeth 150 and grooves 110. FIG. 21 illustrates a configuration with the teeth 150 and grooves 110 with the teeth 150 centered in the grooves and constant axial gaps between the teeth 150 and grooves. FIG. 22 illustrates a preferred arrangement in accordance with the present invention wherein the symmetrical teeth 150 are not centered in the symmetrical grooves 110 but are displaced axially relative a rotor such that the axial gaps on the right-hand side of each tooth 150 are greater than that on the left-hand side. Improved pinching and tearing is believed to occur with the embodiment of FIG. 22 over that of FIG. 21.

In accordance with the present invention, it is preferred that the striker plates 32 used on the rotor 12 and the striker plates 58 used on the anvil are identical modular striker plates. In the preferred embodiment, each striker plate 32 carried on the rotor 12 is preferably offset so as to overlap with two identical striker plates 58 on the anvil. This, of course, is not necessary but preferred.

Each of the rotor discs 26 are illustrated as carrying six lobes 28. Preferably, the individual rotor discs 26 forming the rotor 12 may be identical but are keyed to the shaft 22 at different angular orientations such that preferably only one of the striker plates 32 on the rotor 12 are to pass adjacent the anvil 24 at any one moment.

The modular striker plates of the preferred orientation as illustrated in FIG. 13 are conveniently to be selected of a size such that one striker plate 22 covers the entire axial extent width of a rotor disc 26. In any event, the rotor discs 28 may be selected to have an axial extent to represent an integral number of the length of the cutting side face of the identical striker discs. In the preferred embodiment, the rotor 12 is illustrated as having ten rotor discs 28 and thus having an axial length equal to that of ten rotor discs 32. The anvil 24 is illustrated as carrying eleven stator striker plates 58 each axially offset about 50% relative to the striker plates 32 on the rotor discs 24.

The preferred striker plate 32 has its rear face 88 parallel to its front face 90. As well, it has its first end face 96 parallel to its second end face 98. As well, it has the lands of its right side face 92 and its left side face 94 parallel to each other and normal to the rear face 88 and front face 90 and normal to the first end 96 and second end 98. An advantage of this configuration is that each striker plate, therefore, has four identical cutting edges 100, 102, 104 and 106 and can be oriented and used on the rotor 12 or anvil 24 in one of four separate positions optimizing the length of time that a striker plate can be used.

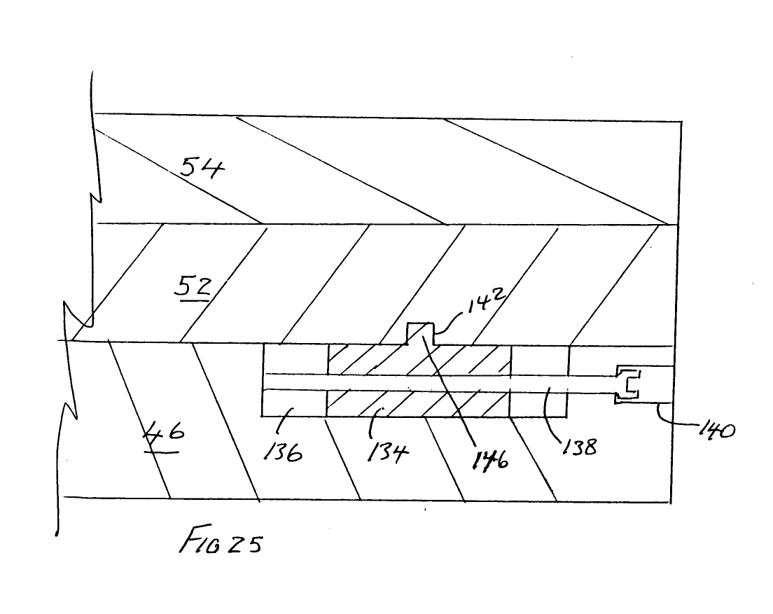

FIG. 26 illustrates a second embodiment of a striker plate 132 within the scope of the present invention in which the lands 108 on each side face of the plate are not perpendicular to the rear face 88 and front face 90 but rather are disposed at an angle thereto as, for example, in the range of between 90° and 40°. The lands 110 on each side face being disposed in parallel land planes 109. With such a configuration, striker plates 132 can be used in one of two different orientations. Each striker plate is preferably symmetrical about a central longitudinal plane passing through the bit so that it may be easily removed, rotated 180° and remounted. The striker plate configuration is adaptable for use with most designs of rotors having radial lobes for that purpose. Each striker plate is mounted to project forwardly and presents a cutting edge and face which is preferably inclined forwardly from the front face of the rotor to present an aggressive rake angle with the radial line through the axis of the rotor in the direction of rotation of the rotor. Identical cutting edges are provided as 102 and 106. In the embodiments of FIG. 26, the axis 112 of each of the grooves 110 is indicated as lying in an axis plane 112 which is parallel to the land plane 109.

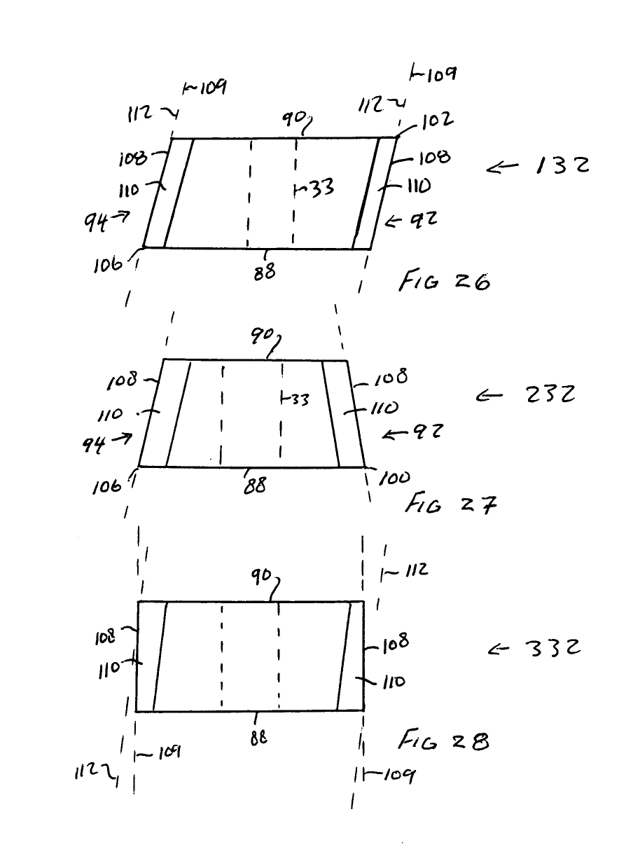

FIG. 27 shows an end view of a fourth embodiment of a striker plate 232 in which the left and right side faces 92 and 94 are not parallel but are disposed to have their lands 108 in land planes 109 at the same angle to the rear face 90. Identical cutting edges are provided as 100 and 106.

FIG. 28 illustrates an end view of a third embodiment of a striker plate 332 in which the axes of the grooves 110 are disposed in an axis plane 112 which is not parallel the land plane 109. Such a striker plate as illustrated in FIG. 22 is intended for use in one of two orientations. When setting up the striker plates on the rotor and anvils, it is important to arrange them so that there is no interference. However, having the axes of the grooves 110 extend in an axis plane 112 not parallel the land plane 109 can provide for the gap between the side faces of opposing striker plates to vary as any two plates move circumferentially past each other through different angular positions.

As seen in FIG. 9, each of the rotor striker plates 32 may be oriented such that a center line 120 between the rear face 88 and the front face 90 of each striker plate on the rotor being disposed along a radius of the rotor 12. Similarly, the anvil striker plates 58 carried on the anvil 24 may also be located such that a center line between its rear face 88 and front face 90 is disposed along a radius of the rotor 12. This is not necessary and either of the striker plates may be canted or raked as to be at an angle to a radius to the rotor.

The striker plates are shown as being mounted to directly engage the rotor 12 or to directly engage the driven wedge 52. This is not necessary and other intermediate mounting devices may be disposed between the striker plate and the rotor or the slider block as may be of assistance, for example, to facilitate removal of each striker plate from the rotor block or anvil, or to provide desired rake angles. The striker plate may be part of a striker plate assembly with the cutting edge portion carried as an insert to a striker carrier in a manner as described in U.S. Pat. No. 5,950,945 to Schaller.

The preferred striker plates as illustrated in FIG. 13 may be machined using conventional computerized control boring and cutting machines at relatively low cost. Having identical modular striker plates for all locations on the rotor and for all locations on the anvil reduces the need to have increased inventory.

Nevertheless, rather than have individual modular striker plates 58 on the anvil, it is possible to have one or more striker plates of longer length than the striker plates provided on the rotor disc. Either single or multiple replaceable striker plates may be used for any particular rotor or anvil.

Preferred striker plates in accordance with the present invention may be made from flat planar sheet metal merely by forming circular bores and straight flat cuts. The illustrated embodiments show both sides of a striker plate 32 being the same. This is not necessary and, for example, the lands on one side may be offset 50% from the lands on the other side.

While the invention has been described with reference to preferred embodiments, many variations and modifications will now occur to persons skilled in the art. For a definition of the invention, reference is made to the following claims.

1. A striker plate for a rotatable rotor or stationary anvil of a rotary comminuting device comprising:
a striker plate having:
a first end face,
a second end face,
a rear face for attachment to a rotor or anvil,
a front face parallel the rear face,
a right cutting side face extending between the rear face and the front face on a right side thereof, and
a left cutting side face extending between the rear face and the front face on a left side thereof,
a right rear cutting edge formed at a juncture between the right side cutting face and the rear face,
a right front cutting edge formed at a juncture between the right side cutting face and the front face,
a left front cutting edge formed at a juncture between the left side cutting face and the front face,
a left rear cutting edge formed at a juncture between the left side cutting face and the rear face,
the right cutting side face comprising a plurality of identical planar right lands interspaced by a plurality of identical, parallel right grooves,
the right lands all lying in the same flat right land plane and each spaced from each adjacent right land by one of the right grooves, the right land plane disposed at a first angle to the rear face,
each right groove comprising a frusto-cylindrical surface of an angular extent not greater than 180 degrees about a respective groove axis extending at a second angle to the rear face,
each respective groove axis for all of the right grooves lying in a same right axis plane,
the left cutting side face comprising a plurality of identical planar left lands interspaced by a plurality of identical, parallel left grooves,
the left lands all lying in the same flat left land plane and each spaced from each adjacent left land by one of the left grooves, the left land plane disposed at the first angle to the rear face,
each left groove comprising a frusto-cylindrical surface of an angular extent not greater than 180 degrees about a respective groove axis extending at the second angle to the rear face,
each respective groove axis for all of the left grooves lying in a same left axis plane,
the right land plane parallel to the left land plane.

2. A striker plate as claimed in claim 1 wherein the right axis plane is parallel the right land plane and the left axis plane is parallel the left land plane.

3. A striker plate as claimed in claim 1 wherein the first angle is 90 degrees.

4. A striker plate as claimed in claim 2 wherein the right axis plane is parallel the right land plane and the left axis plane is parallel the left land plane.

5. A striker plate as claimed in claim 3 wherein the angular extent of each groove about its respective axis is in the range of 120 to 180 degrees.

6. A striker plate as claimed in claim 1 wherein the striker plate is made in a process comprising the steps of:
a. providing a flat sheet of metal with opposed planar surfaces to become the rear face and front face,
b. forming a plurality of straight parallel rows of spaced bores with each row comprising a plurality of parallel cylindrical bores through the sheet at the same first angle to the rear surface with each bore in the row to be about a bore axis which lies in a same bore plane and are spaced an equal distance from adjacent bores in the row, and
c. cutting through the sheet along a plurality of flat planar cut lines, one cut line for each row of bores in a plane parallel to the bore plane for that row of bores and passing through the bores of that row at or to one side of the bore axis,
wherein each land is formed as segments of a cut line for a row of bores between adjacent bores in a row of bores and each groove comprises a portion of a bore between the lands.

7. A striker plate as claimed in claim 6 wherein the process includes heat treating the metal sheet after steps (a) to (c).

8. A striker plate as claimed in claim 6 wherein step (c) divides the sheet into portions from which at least two striker plates are to be formed, one portion on each side of the cut line.

9. A striker plate as claimed in claim 8 including a further step of:
d. cutting through the sheet along a plurality of a flat planar end cut line in a plane transverse to the land planes and passing through the bore axis of bores in different rows.

10. A striker plate as claimed in claim 1 including at least one bore through the striker plate from the front face to the rear face adapted to receive a fastener adapted to secure the striker plate to a rotor or anvil.

11. A striker plate as claimed in claim 1 including at least two bores through the striker plate from the front face to the rear face adapted to receive a fasteners to secure the striker plate to a rotor or anvil,
the bores spaced from each other along a longitudinal extending between first and second end faces.

12. A striker plate as claimed in claim 1 which is machined from a flat planar sheet of metal merely by forming circular bores therethrough and cutting along flat planar cut lines.

13. A comminuting apparatus having:
a rotor for rotation about a horizontal axis relative to a stator,
the rotor having replaceable rotor striker plates secured thereto with a cutting side surface disposed radially outwardly from an outer most radial perimeter of the rotor,
the cutting side surface of the rotor having axially spaced rotor teeth with radially inwardly extending rotor grooves between adjacent rotor teeth,
a stationary anvil fixed to the stator radially outwardly of the rotor extending axially of the rotor and presenting replaceable anvil striker plates secured thereto with a cutting side surface disposed radially inwardly from an inner most radial perimeter of the stator towards the rotor,
the cutting side surface of the stator having axially spaced stator teeth with radially inwardly extending stator grooves between adjacent stator teeth,
the stator teeth alternating axially with the rotor teeth with each stator tooth disposed in a rotor groove spaced therefrom extending radially inwardly into the rotor groove radially inwardly of the radially outermost portions of the adjacent rotor teeth and with each rotor tooth disposed in a stator groove extending radially outwardly into the stator groove radially outwardly of the radially innermost portions of the adjacent stator teeth,
wherein at every axial point a radially extending gap is provided between the cutting side surface of the rotor striker plates and the cutting side surface of the stator striker plates,
the radially extending gap varying in radial extent over the axial extent of at least some of the stator grooves and rotor grooves.

14. A comminuting apparatus as claimed in claim 13 wherein:
the radially outermost portions of rotor teeth within the stator grooves spaced by an axially extending gap from the radially innermost portions of adjacent stator teeth within the rotor grooves,
the axially extending gap varying in axial extent over the radial extent of each of a plurality of the radially outermost portions of rotor teeth within the stator grooves or the radially innermost portions of adjacent stator teeth within the rotor grooves.

15. A comminuting apparatus as claimed in claim 13 wherein the rotor striker plates and stator striker plates are identical.

16. A comminuting apparatus as claimed in claim 13 wherein each striker plate comprising:
an elongate generally rectangular striker plate having:
a first end face,
a second end face,
a rear face for attachment to a rotor or anvil,
a front face parallel the rear face,
a right cutting side face extending between the rear face and the front face on right side thereof, and
a left cutting side face between the rear face and the front face on a left side thereof,
a right rear cutting edge formed at a juncture between the right side cutting face and the rear face,
a right front cutting edge formed at a juncture between the right side cutting face and the front face,
a left front cutting edge formed at a juncture between the left side cutting face and the front face,
a left rear cutting edge formed at a juncture between the left side cutting face and the rear face,
the right cutting side face comprising a plurality of identical planar right lands interspaced by a plurality of identical, parallel right grooves,
the right lands all lying in the same flat right land plane and each spaced from each adjacent right land by one of the right grooves, the right land plane disposed at a first angle to the rear face,
each right groove comprising a frusto-cylindrical surface of an angular extent not greater than 180 degrees about a respective groove axis extending at a second angle to the rear face,
each respective groove axis for all of the right grooves lying in a same right axis plane,
the left cutting side face comprising a plurality of identical planar left lands interspaced by a plurality of identical, parallel left grooves,
the left lands all lying in the same flat left land plane and each spaced from each adjacent left land by one of the left grooves, the left land plane disposed at the first angle to the rear face,
each left groove comprising a frusto-cylindrical surface of an angular extent not greater than 180 degrees about a respective groove axis extending at the second angle to the rear face,
each respective groove axis for all of the left grooves lying in a same left axis plane,
the right land plane parallel to the left land plane.

17. A striker plate as claimed in claim 16 wherein the first angle is 90 degrees.

18. A striker plate as claimed in claim 17 wherein the angular extent of each groove about its respective axis is in the range of 120 to 180 degrees.

19. A striker plate as claimed in claim 11 wherein each land has an axial extent which is less than the axial extent of each groove.

20. A striker plate as claimed in claim 19 wherein each groove has the same groove radius relative an axis about which its frusto-cylindrical surface is disposed, each land has an axial extent which is in the range of 0.95 to 0.25 times the groove radius.
